(19) United States
(12) Patent Application Publication
(10) Pub. No.: US 2012/0177908 A1
(43) Pub. Date: Jul. 12, 2012

(54) THERMAL SPRAY COATINGS FOR SEMICONDUCTOR APPLICATIONS

(76) Inventors: Christopher Petorak, Carmel, IN (US); Graeme Dickinson, Scottsdale, AZ (US)

(21) Appl. No.: 13/180,592

(22) Filed: Jul. 12, 2011

Related U.S. Application Data
(60) Provisional application No. 61/364,224, filed on Jul. 14, 2010.

(51) Int. Cl. B32B 18/00; C09D 1/00; B32B 5/14; C23C 4/10

(52) U.S. Cl. 428/310.5; 427/453; 106/286.1

(57) ABSTRACT

This invention relates to thermal spray coatings on a metal or non-metal substrate. The thermal spray coating comprises a ceramic coating having a functionally graded porosity across the ceramic coating thickness. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity extending from the surface of the inner layer to the surface of the ceramic coating sufficient to provide corrosion resistance and/or plasma erosion resistance to said ceramic coating. This invention also relates to methods of protecting metal and non-metal substrates by applying the thermal spray coatings. The coatings are useful, for example, in the protection of semiconductor manufacturing equipment, e.g., integrated circuit, light emitting diode, display, and photovoltaic, internal chamber components, and electrostatic chuck manufacture.

### RELATED APPLICATIONS

The present application claims priority from U.S. Provisional Application Ser. No. 61/364,224, filed Jul. 14, 2010, which is incorporated by reference herein in its entirety.

### FIELD OF THE INVENTION

This invention relates to thermal spray coatings for use in harsh conditions, e.g., coatings that provide erosive and corrosive barrier protection in harsh environments such as plasma treating vessels that are used in semiconductor device manufacture. In particular, it relates to coatings useful for extending the service life of plasma treating vessel components under severe conditions, such as those components that are used in semiconductor device manufacture. The coatings provide erosion and corrosion resistance at processing temperatures higher than conventional processing temperatures used in the semiconductor etch industry, e.g., greater than 100° C. The invention is useful, for example, in the protection of semiconductor manufacturing equipment, e.g., integrated circuit, light emitting diode, display, and photovoltaic, internal chamber components, and electrostatic chuck manufacture.

### BACKGROUND OF THE INVENTION

Thermal spray coatings can be used for the protection of equipment and components used in erosive and corrosive environments. In a semiconductor wafer manufacturing operation, the interior of a processing chamber is exposed to a variety of erosive and corrosive or reactive environments that can result from corrosive gases or other reactive species, including radicals or byproducts generated from process reactions. For example, a halogen compound such as a chloride, fluoride or bromide is typically used as a treating gas in the manufacture of semiconductors. The halogen compound can be disassociated to atomic chlorine, fluorine or bromine in plasma treating vessels used in semiconductor device manufacture, thereby subjecting the plasma treating vessel to a corrosive environment.

Additionally, in plasma treating vessels used in semiconductor device manufacture, the plasma contributes to the formation of finely divided solid particles and also ion bombardment, both of which can result in erosion damage of the process chamber and component parts.

Also, etch operators are performing more processes that result in substantial undesirable byproducts, e.g., polymeric films, and as such are increasing the severity of the cleaning process required for the process chamber and component parts. When exposed to wet cleaning solutions during cleaning cycles of the process chamber and component parts, byproducts generated from plasma-treating chamber operations, such as chlorides, fluorides and bromides, can react to form corrosive species such as HCl and HF, in addition to the corrosive species that may be present in the cleaning cycle, e.g., HCl, HF and HNO₃. The cleaning solutions themselves can be corrosive.

Erosion and corrosion resistant measures are needed to ensure process performance and durability of the process chamber and component parts. There is a need in the art to provide improved erosion and corrosion resistant coatings and to reduce the level of corrosive attack by process reagents. Particularly, there is a need in the art to improve coating properties to provide corrosion and erosion resistance of thermally sprayed coated equipment and components in plasma treating vessels used in semiconductor device manufacture.

Because higher processing temperatures for etch tools leads to higher etch rates (both metal and dielectric etch) which leads to higher wafer throughput for etch processes, erosion and corrosion resistant measures are needed at processing temperatures that are higher than conventional processing temperatures used in the semiconductor etch industry, e.g., greater than 100° C.

### SUMMARY OF THE INVENTION

This invention relates in part to a thermal spray coating on a metal or non-metal substrate, the thermal spray coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating.

The thermal spray coatings of this invention have a functionally graded porosity across the ceramic coating thickness that can be smooth or discrete. The inner layer can comprise one or more sublayers. Likewise, the outer layer can comprise one or more sublayers. The inner layer can have a smooth or discrete functionally graded porosity across the inner layer thickness. Likewise, the outer layer can have a smooth or discrete functionally graded porosity across the outer layer thickness.

This invention also relates in part to a process for producing a thermal spray coating on a metal or non-metal substrate, the thermal spray coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating; the process comprising (i) feeding at least one ceramic coating material to a thermal spray device, (ii) operating the thermal spray device to deposit the at least one ceramic coating material on the metal or non-metal substrate to produce the ceramic coating, and (iii) varying at least one operating parameter of the thermal spray device during deposition of the at least one ceramic coating material sufficient to vary porosity of the ceramic coating.

This invention further relates in part to an article comprising a metal or non-metal substrate and a thermal spray coating on the surface thereof; the thermal spray coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating.

This invention yet further relates in part to an article comprising a metal or non-metal substrate and a thermal spray coating on the surface thereof; the thermal spray coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating; the article prepared by a process comprising (i) feeding at least one ceramic coating material to a thermal spray device, (ii) operating the thermal spray device to deposit the at least one ceramic coating material on the metal or non-metal substrate to produce the ceramic coating, and (iii) varying at least one operating parameter of the thermal spray device during deposition of the at least one ceramic coating material sufficient to vary porosity of the ceramic coating.

This invention also relates in part to a method for protecting a metal or non-metal substrate, the method comprising applying a thermally sprayed coating to the metal or non-metal substrate, the thermally sprayed coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating.

This invention further relates in part to an internal member for a plasma treating vessel comprising a metallic or ceramic substrate and a thermal spray coating on the surface thereof; the thermal spray coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating.

This invention yet further relates in part to a method for producing an internal member for a plasma treating vessel, the method comprising applying a thermally sprayed coating to the internal member, the thermally sprayed coating comprising a ceramic coating having a functionally graded porosity across the ceramic coating thickness, the thickness extending along a path starting at a point adjacent to the surface of the metal or non-metal substrate and proceeding to a point on the surface of the ceramic coating, the ceramic coating comprising an inner layer and an outer layer, the inner layer having a porosity at or near the interface of the inner layer and the metal or non-metal substrate sufficient to provide a compliant ceramic coating capable of straining under thermal expansion mismatch between the ceramic coating and the metal or non-metal substrate at elevated temperature, and the outer layer having a decreasing porosity from the surface of the inner layer to the surface of the ceramic coating sufficient to provide corrosion resistance and/or plasma erosion resistance to the ceramic coating.

This invention provides improved erosion and corrosion resistant coatings, particularly those of the ceramic oxides, e.g., zirconia, yttria, alumina, and alloys and mixtures thereof, to reduce the level of erosive and corrosive attack by process reagents. Particularly, this invention provides corrosion and erosion resistance to thermally sprayed coated equipment and components in plasma treating vessels used in semiconductor device manufacture, e.g., metal and dielectric etch processes. The coatings of this invention provide erosion and corrosion resistance at processing temperatures higher than conventional processing temperatures used in the semiconductor etch industry, e.g., greater than 100° C. The coatings also exhibit low particle generation, low metals contamination, and desirable thermal, electrical and adhesion characteristics.

### BRIEF DESCRIPTION OF THE DRAWINGS

FIG. 1 is a scanning electron microscope (SEM) micrograph of coating cross-sections for various porosity levels, a) 0-0.5% (low), which increases for b) 0.5-1.0% (medium), and again increases for c) 1.0-2.5% (high).

FIG. 2 is a SEM micrograph of coating cross-sections for coatings with functionally graded porosity. The top micrograph presents a coating with two levels of porosity: medium porosity at the interface and low porosity at the surface. The bottom micrograph presents a coating with three levels of porosity: medium porosity at the interface, high porosity in the interior, and low porosity at the surface.

FIG. 3 graphically depicts the 2-D void area measured by cross-sectional analysis method ASTM E 2109-01 versus the total porosity levels as measured by the density method ASTM B 328-96 for the coatings presented in FIGS. 1(a, b and c). Increases in 2-D void area are linked to increases in total porosity.

FIG. 4 graphically depicts the hardness as a function of the density for the coatings presented in FIGS. 1(a, b and c). Coatings with higher density, i.e. lower porosity, result in a higher Vickers Hardness number.

FIG. 5 graphically depicts compressive modulus as a function of the density for coatings presented in FIGS. 1(a, b and c). Coatings with higher density, i.e. lower porosity, result in a less compliant coating, i.e. a coating with a higher compressive modulus.

FIG. 6 graphically depicts material loss due to reactive ion etch (RIE) for yttria coatings of various relative densities. A linear relationship was observed for the CF₄:O₂ chemistry, where coatings with higher relative densities provide increased plasma erosion protection.

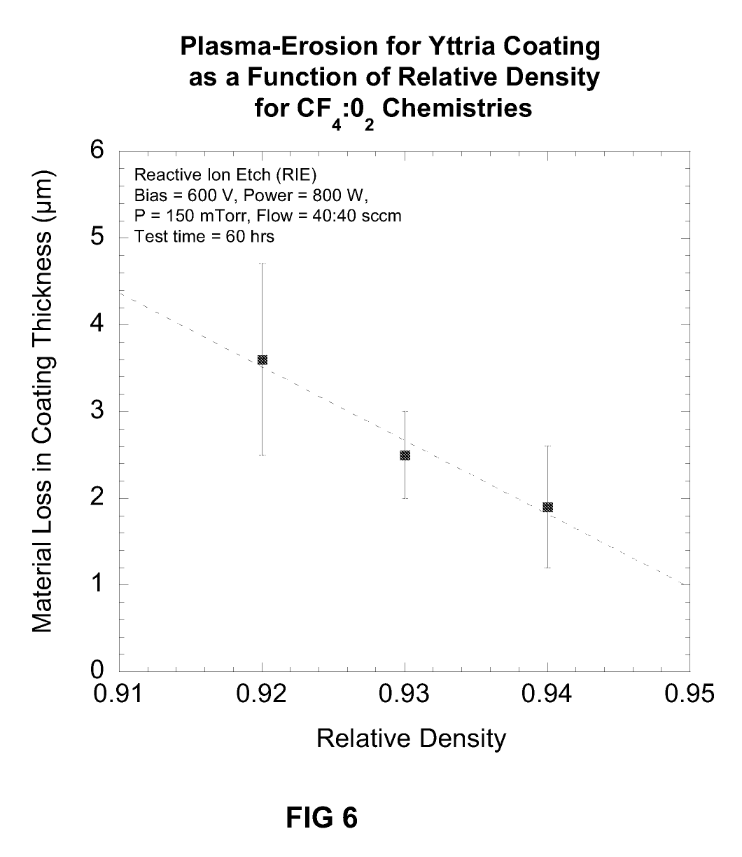

FIG. 7 graphically depicts tensile bond strength results of the as-coated versus the thermally cycled conditions of standard yttria coatings, i.e. baseline, and yttria coatings with functionally graded porosity. The thermally cycled samples were heated between room temperature and 300° C. for a total of 10 cycles.

### DETAILED DESCRIPTION OF THE INVENTION

This invention can minimize damage due to chemical corrosion through a halogen gas and also damage due to plasma erosion. When an internal member component is used in an environment containing the halogen excited by the plasma, it is important to prevent plasma erosion damage caused by ion bombardment, which is then effective to prevent the chemical corrosion caused by halogen species. Byproducts generated from the process reactions include halogen compounds such as chlorides, fluorides and bromides. When exposed to atmosphere or wet cleaning solutions during the cleaning cycles, the byproducts can react to form corrosive species such as HCl and HF, in addition to the corrosive species that may be present in the cleaning cycle, e.g., HCl, HF and HNO₃. The cleaning solutions themselves can be corrosive. The thermal spray coatings of this invention provide erosion and corrosion resistance at processing temperatures higher than conventional processing temperatures used in the semiconductor etch industry, e.g., greater than 100° C.

This invention provides a solution to the damage incurred by internal members of the plasma-treating vessels. This invention can minimize damage resulting from aggressive cleaning processes and chemistries, e.g., CF₄/O₂, CF₄/O₂, SF₆/O₂, BCl₃, and HBr based plasma dry cleaning procedures, used on the internal member components. Because etch operators are performing more processes that result in substantial undesirable byproducts, e.g., polymeric films, increasing the severity of the cleaning process is required to provide process chamber and component parts suitable for semiconductor applications. For example, when exposed to wet cleaning solutions during cleaning cycles of the process chamber and component parts, byproducts generated from plasma-treating chamber operations, such as chlorides, fluorides and bromides, can react to form corrosive species such as HCl and HF, in addition to the corrosive species that may be present in the cleaning cycle, e.g., HCl, HF and HNO₃. The cleaning solutions themselves can be corrosive. This invention can minimize damage due to corrosion resulting from the severe cleaning process. The coated internal member components of this invention can withstand these more aggressive cleaning procedures.

The ceramic materials useful in the thermal spray coatings of this invention include, for example, at least one of yttrium oxide, zirconium oxide, magnesium oxide (magnesia), cerium oxide (ceria), hafnium oxide (hafnia), aluminum oxide, oxides of Groups 2A to 8B inclusive of the Periodic Table and the Lanthanide elements, or alloys or mixtures or composites thereof. Preferably, the coating materials include at least one of yttrium oxide, zirconium oxide, aluminum oxide, cerium oxide, hafnium oxide, gadolinium oxide (gadolinia), ytterbium oxide (ytterbia), or alloys or mixtures or composites thereof. Most preferably, the coating material is yttrium oxide.

With the above materials, the surfaces of thermally sprayed coatings applied to a plasma treatment vessel or an internal member component used in such a vessel are much more resistant to degradation than bare aluminum, anodized aluminum or sintered aluminum oxide by corrosive gases in combination with radio frequency electric fields which generate gas plasma. Other illustrative coating materials include silicon carbide or boron carbide. With these materials, the surfaces in contact with the etching plasma are those of thermally sprayed coatings applied to a plasma etch chamber or component used in the plasma etch processing of silicon wafers for the manufacture of integrated circuits.

The average particle size of the ceramic materials, e.g., powders (particles), useful in this invention is preferably set according to the type of thermal spray device and thermal spraying conditions used during thermal spraying. The ceramic powder particle size (diameter) can range from about 1 to about 150 microns, preferably from about 1 to about 100 microns, more preferably from about 5 to about 75 microns, and most preferably from about 5 to about 50 microns. The average particle size of the powders used to make the ceramic powders useful in this invention is preferably set according to the type of ceramic powder desired. Typically, individual particles useful in preparing the ceramic powders useful in this invention range in size from nano size to about 5 microns in size. Submicron particles are preferred for preparing the ceramic powders useful in this invention.

The thermal spraying powders useful in this invention can be produced by conventional methods such as agglomeration (spray dry and sinter or sinter and crush methods) or cast and crush. In a spray dry and sinter method, a slurry is first prepared by mixing a plurality of raw material powders and a suitable dispersion medium. This slurry is then granulated by spray drying, and a coherent powder particle is then formed by sintering the granulated powder. The thermal spraying powder is then obtained by sieving and classifying (if agglomerates are too large, they can be reduced in size by crushing). The sintering temperature during sintering of the granulated powder is preferably 800 to 1600° C. Plasma densification of spray dried and sintered particles and also cast and crush particles can be conducted by conventional methods. Also, atomization of ceramic oxide melts can be conducted by conventional methods.

The thermal spraying powders useful in this invention may be produced by another agglomeration technique, sinter and crush method. In the sinter and crush method, a compact is first formed by mixing a plurality of raw material powders followed by compression and then sintered at a temperature between 1200 to 1400° C. The thermal spraying powder is then obtained by crushing and classifying the resulting sintered compact into the appropriate particle size distribution.

The thermal spraying powders useful in this invention may also be produced by a cast (melt) and crush method instead of agglomeration. In the melt and crush method, an ingot is first formed by mixing a plurality of raw material powders followed by rapid heating, casting and then cooling. The thermal spraying powder is then obtained by crushing and classifying the resulting ingot.

The thermally sprayed coatings useful in this invention can be made from a ceramic powder comprising ceramic powder particles, wherein the average particle size of the ceramic powder particles can range from about 1 to about 150 microns.

As indicated above, this invention relates to a thermal spray coating on a metal or non-metal substrate. The thermal spray coating is a ceramic coating having a functionally graded porosity across the ceramic coating thickness. The thickness extends along a path starting at a point adjacent to the surface of the metal or non-metal substrate and proceeds to a point on the surface of the ceramic coating. The ceramic coating has an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating. A preferred ceramic coating is a yttrium oxide coating.

With regard to these ceramic coatings having an inner layer and an outer layer, the thickness of these coatings can range from about 0.0001 to about 0.1 inches, preferably from about 0.005 to about 0.05 inches, more preferably from about 0.005 to about 0.01 inches. The thickness of the inner layer can range from about 0.0005 to about 0.1 inches, preferably from about 0.001 to about 0.006 inches, and more preferably from about 0.002 to about 0.004 inches. The thickness of the outer layer can range from about 0.0005 to about 0.1 inches, preferably from about 0.001 to about 0.006 inches, and more preferably from about 0.002 to about 0.004 inches.

The ceramic coatings of this invention have a functionally graded porosity across the ceramic coating thickness. As used herein, the thickness extends along a path starting at a point adjacent to the surface of the metal or non-metal substrate and proceeds to a point on the surface of the ceramic coating. The ceramic coatings have an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to the ceramic coating.

The inner layer of the ceramic coatings typically has a porosity of from about 5% to about 18%, preferably from about 6% to about 10%, and more preferably from about 6% to about 8%. The outer layer of the ceramic coatings has a porosity that decreases from the surface of the inner layer to the surface of the ceramic coating, i.e., along a path starting at a point adjacent to the surface of the inner layer and proceeding to a point on the surface of the ceramic coating. The outer layer porosity can range from about 1% to about 18%, preferably from about 4% to about 8%, and more preferably from about 4% to about 5%. In addition, a continuous grading in porosity can be utilized, either throughout the entire coating or within a discrete inner or outer layer. The coating or the inner or outer layers can be graded from an interface to gradually decrease from about 18% to about 1%, preferably from about 10% to about 5%, and more preferably from about 6% to about 4%, at the free surface. For purposes of this invention, porosity is measured by the Archimedes method (ASTM B328-73).

As indicated above, the inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The inner layer is a compliant material capable of withstanding stresses due to the thermal expansion mismatch between the metal or non-metal substrate and the ceramic coating. This mismatch in thermal expansion between the inner layer and the metal or non-metal substrate can lead to crack propagation at the inner layer or undercoat layer/substrate interface. An important function of the inner layer is to reduce interfacial stresses at the inner layer/substrate interface, so that the inner layer can accommodate thermal expansion of a substrate at high temperature without catastrophic cracking and spallation.

Erosion and corrosion resistant properties of the thermal spray coatings of this invention can be further improved by blocking or sealing the inter-connected residual micro-porosity inherent in thermally sprayed coatings. Sealers can include hydrocarbon, siloxane, or polyimid based materials with out-gassing properties of <1% TML (total mass loss) and <0.05 CVCM (collected condensable volatile materials), preferably <0.5% TML, <0.02% CVCM. Sealants can also be advantageous in semiconductor device manufacture as sealed coatings on internal chamber components and electrostatics chucks will reduce chamber conditioning time when compared to as-coated or sintered articles. Conventional sealants can be used in the methods of this invention. The sealants can be applied by conventional methods known in the art.

As indicated above, this invention relates to a process for producing a thermal spray coating on a metal or non-metal substrate. The thermal spray coating is a ceramic coating having a functionally graded porosity across the ceramic coating thickness. The thickness extends along a path starting at a point adjacent to the surface of the metal or non-metal substrate, and proceeds to a point on the surface of the ceramic coating. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating. The process involves (i) feeding at least one ceramic coating material to a thermal spray device, (ii) operating the thermal spray device to deposit the at least one ceramic coating material on the metal or non-metal substrate to produce the ceramic coating, and (iii) varying at least one operating parameter of the thermal spray device during deposition of the at least one ceramic coating material sufficient to vary porosity of the ceramic coating.

As indicated above, this invention relates to an article that comprises a metal or non-metal substrate and a thermal spray coating on the surface thereof. The thermal spray coating comprises a ceramic coating having a functionally graded porosity across the ceramic coating thickness. The thickness extends along a path starting at a point adjacent to the surface of the metal or non-metal substrate and proceeds to a point on the surface of the ceramic coating. The ceramic coating comprises an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to the ceramic coating.

As indicated above, this invention relates to an article that comprises a metal or non-metal substrate and a thermal spray coating on the surface thereof. The article is prepared by a process that includes (i) feeding at least one ceramic coating material to a thermal spray device, (ii) operating the thermal spray device to deposit the at least one ceramic coating material on the metal or non-metal substrate to produce the ceramic coating, and (iii) varying at least one operating parameter of the thermal spray device during deposition of the at least one ceramic coating material sufficient to vary porosity of the ceramic coating. The thermal spray coating is a ceramic coating having a functionally graded porosity across the ceramic coating thickness. The thickness extends along a path starting at a point adjacent to the surface of the metal or non-metal substrate, and proceeds to a point on the surface of the ceramic coating. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating.

Coatings may be produced using the ceramic powders described above by a variety of methods well known in the art. These methods include thermal spray (plasma, HVOF, detonation gun, etc.), electron beam physical vapor deposition (EBPVD), laser cladding; and plasma transferred arc. Thermal spray is a preferred method for deposition of the ceramic powders to form the erosive and corrosive resistant coatings of this invention. The erosion and corrosion resistant coatings of this invention are formed from ceramic powders having the same composition. Such methods may also be used for deposition of the coating layers.

The ceramic coating can be deposited onto a metal or non-metal substrate using any thermal spray device by conventional methods. Preferred thermal spray methods for depositing the ceramic coatings are plasma spraying including inert gas shrouded plasma spraying and low pressure or vacuum plasma spraying in chambers. Other deposition methods that may be useful in this invention include high velocity oxygen-fuel torch spraying, detonation gun coating and the like. The most preferred method is inert gas shrouded plasma spraying and low pressure or vacuum plasma spraying in chambers. It could also be advantageous to heat treat the ceramic coating using appropriate times and temperatures to achieve a good bond for the ceramic coating to the substrate and a high sintered density of the ceramic coating. Other means of applying a uniform deposit of powder to a substrate in addition to thermal spraying include, for example, electrophoresis, electroplating and slurry deposition.

The coating material is typically fed to the thermal spray device in the form of powder, although one or more of the constituents could be fed in the form of wire or rod. When the coating material are in the form of powder it may be blended mechanically and fed from a single powder dispenser to the thermal spray device or fed from two or more powder dispensers to the thermal spray device. Multiple thermal spray devices may be used in the process of this invention. The coating material may be fed to the thermal spray device internally as in most detonation gun and high velocity oxygen fuel devices or externally as in many plasma spray devices. The changes in deposition parameters including gas composition and flow rates, power levels, surface speed, coating material injection rates, and torch position relative to the substrate may be changed during the deposition process either manually by the equipment operator or automatically by computer control.

In those situations in which the thermal spray device is a detonation gun, the thermal content of the gas stream in the gun, as well as the velocity of the gas stream, can be varied by changing the composition of the gas mixtures. Both the fuel gas composition and the ratio of fuel to oxidant can be varied. The oxidant is usually oxygen. In the case of detonation gun deposition, the fuel is usually acetylene. In the case of Super D-Gun deposition, the fuel is usually a mixture of acetylene and another fuel such as propylene. The thermal content can be reduced by adding a neutral gas such as nitrogen.

In those situations in which the thermal spray device is a high velocity oxygen fuel torch or gun, the thermal content and velocity of the gas stream from the torch or gun can be varied by changing the composition of the fuel and the oxidant. The fuel may be a gas or liquid as described above. The oxidant is usually oxygen gas, but may be air or another oxidant.

The process of this invention preferably employs plasma spray methodology. The plasma spraying is suitably carried out using fine agglomerated powder particle sizes, typically having an average agglomerated particle size of less than about 50 microns, preferably less than about 40 microns, and more preferably from about 5 to about 50 microns. Individual particles useful in preparing the agglomerates typically range in size from submicron size to about 5 microns in size. The plasma medium can be nitrogen, hydrogen, argon, helium or a combination thereof.

The thermal content of the plasma gas stream can be varied by changing the electrical power level, gas flow rates, or gas composition. Argon is usually the base gas, but helium, hydrogen and nitrogen are frequently added. The velocity of the plasma gas stream can also be varied by changing the same parameters.

Variations in gas stream velocity from the plasma spray device can result in variations in particle velocities and hence dwell time of the particle in flight. This affects the time the particle can be heated and accelerated and, hence, its maximum temperature and velocity. Dwell time is also affected by the distance the particle travels between the torch or gun and the surface to be coated.

The specific deposition parameters depend on both the characteristics of the plasma spray device and the materials being deposited. The rate of change or the length of time the parameters are held constant are a function of both the required coating composition, the rate of traverse of the gun or torch relative to the surface being coated, and the size of the part. Thus, a relatively slow rate of change when coating a large part may be the equivalent of a relatively large rate of change when coating a small part.

The invention relates to a thermal spray process for the deposition of coatings with a graded porous composition and the coated articles produced thereby. More particularly, the invention relates to feeding at least one coating material to a thermal spray device and continuously or intermittently changing the density of the deposited coatings by changing the thermal spray operating parameters. The continuous change in the density of the coating material during deposition creates a smoothly graded porous coating structure. The intermittent change in the density of the coating material during deposition creates a discretely graded porous coating structure.

The invention relates to a process for producing a graded porous thermal spray coating on a substrate comprising the feeding of at least one coating material to a thermal spray device and varying at least one of the deposition parameters of the thermal spray device during the deposition operating thereby varying the density of the deposited coating material to produce a smoothly or discretely graded porous coated coating on the substrate. The thermal spray device useful in the process of this invention has parameters that can control or monitor the temperature of the depositing coating material and the velocity of the coating material particles.

The invention also relates to deposition by the coating process of this invention of unique coating structures with smoothly or discretely varying gradations in density properties. Since the changes in deposition parameters can be made while the coating is being continuously or intermittently deposited, the gradation or changes in density properties can be very smooth or discrete. If the coating is being continuously deposited, the gradation or changes in density properties can be very smooth. If the coating is being intermittently deposited, the gradation or changes in density properties can be very discrete.

In most cases, however, the coating device and substrate can be moved relative to each other and the coating is deposited in multiple layers or sublayers. Using the process of this invention, each layer or sublayer may be slightly different than the preceding or succeeding layer or sublayer. The time between layers or sublayers is only dependent on the size of the substrate and the traverse rate (the relative rate of motion between the coating device and the substrate) and the advance rate (the distance a torch advances across a part after a single stroke or RPM (rotation per minute)), since coating is being deposited continuously by the coating device. The difference between layers or sublayers is a function of the rate of change in deposition parameters and the traverse rate. The smoothness or discreteness of the gradation is then a function of the thickness of the individual layers that can be made very thin.

The total thickness of the coating is a function of the requirements of the application. The total thickness of the coating is typically in the range of 0.004 to 0.020 inches, but may be thicker or thinner if it is necessary to satisfy the specific requirements of the application. This invention also relates to articles with the graded porous coatings of this invention. Such articles include those requiring coatings with graded porous properties to enhance the corrosion resistance and plasma erosion resistance of the coating.

The thermal spray coatings have a functionally graded porosity across the ceramic coating thickness that can be smooth or discrete. The inner layer can comprise one or more sublayers. Likewise, the outer layer can comprise one or more sublayers. The inner layer can have a smooth or discrete functionally graded porosity across the inner layer thickness. Likewise, the outer layer can have a smooth or discrete functionally graded porosity across the outer layer thickness.

As indicated above, a suitable thickness for the thermally sprayed coatings of this invention can range from about 0.001 to about 0.1 inches depending on any allowance for dimensional grinding, the particular application and the thickness of any other layers. For typical applications and erosive and corrosive environments, the coating thickness may range from about 0.001 to about 0.05 inches, preferably from about 0.005 to about 0.01 inches, but thicker coatings will be needed to accommodate reduction in final thickness by any abrading procedure. In other words, any such abrading procedure will reduce the final thickness of the coating.

Illustrative metallic and non-metallic internal member substrates include, for example, aluminum and its alloys, typified by aluminum 6061 in the T6 condition and sintered aluminum oxide. Other illustrative substrates include various steels inclusive of stainless steel, nickel, iron and cobalt based alloys, tungsten and tungsten alloy, titanium and titanium alloy, molybdenum and molybdenum alloy, and certain non-oxide sintered ceramics, and the like.

In an embodiment, an internal aluminum member can be anodized prior to applying said thermal spray coating. A few metals can be anodized but aluminum is the most common. Anodization is a reaction product formed in situ by anodic oxidation of the substrate by an electrochemical process. The anodic layer formed by anodization is aluminum oxide which is a ceramic.

Other suitable metal substrates include, for example, nickel base superalloys, nickel base superalloys containing titanium, cobalt base superalloys, and cobalt base superalloys containing titanium. Preferably, the nickel base superalloys would contain more than 50% by weight nickel and the cobalt base superalloys would contain more than 50% by weight cobalt. Illustrative non-metal substrates include, for example, permissible silicon-containing materials.

As indicated above, this invention relates to a method for producing an internal member for a plasma treating vessel. The method involves applying a thermally sprayed coating to an internal member. The thermally sprayed coating is a ceramic coating having a functionally graded porosity across the ceramic coating thickness. The thickness extends along a path starting at a point adjacent to the surface of the metal or non-metal substrate, and proceeds to a point on the surface of the ceramic coating. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating.

The coated internal members of this invention can be prepared by flowing powder through a thermal spraying device that heats and accelerates the powder onto a base (substrate). Upon impact, the heated particle deforms resulting in a thermal sprayed lamella or splat. Overlapping splats make up the coating structure. A plasma spray process useful in this invention is disclosed in U.S. Pat. No. 3,016,447, the disclosure of which is incorporated herein by reference. A detonation process useful in this invention is disclosed in U.S. Pat. Nos. 4,519,840 and 4,626,476, the disclosures of which are incorporated herein by reference, which include coatings containing tungsten carbide cobalt chromium compositions. U.S. Pat. No. 6,503,290, the disclosure of which is incorporated herein by reference, discloses a high velocity oxygen fuel process that may be useful in this invention to coat compositions containing W, C, Co, and Cr. Cold spraying methods known in the art may also be useful in this invention. Typically, such cold spraying methods use liquid helium gas which is expanded through a nozzle and allowed to entrain powder particles. The entrained powder particles are then accelerated to impact upon a suitably positioned workpiece.

In coating the internal members of this invention, the thermal spraying powder is thermally sprayed onto the surface of the internal member, and as a result, a thermal sprayed coating is formed on the surface of the internal member. High-velocity-oxygen-fuel or detonation gun spraying are illustrative methods of thermally spraying the thermal spraying powder. Other coating formation processes include plasma spraying, plasma transfer arc (PTA), or flame spraying. For electronics applications, plasma spraying is preferred for zirconia, yttria and alumina coatings because there is no hydrocarbon combustion and therefore no source of contamination. Plasma spraying uses clean electrical energy. Preferred coatings for thermally spray coated articles of this invention include, for example, yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

As indicated above, this invention relates to an internal member for a plasma treating vessel that comprises a metallic or ceramic substrate and a thermal spray coating on the surface thereof. The thermal spray coating is a ceramic coating having a functionally graded porosity across the ceramic coating thickness. The thickness extends along a path starting at a point adjacent to the surface of the metal or non-metal substrate, and proceeds to a point on the surface of the ceramic coating. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating.

Illustrative internal member components for a plasma treating vessel used in the production of an integrated circuit include, for example, a deposit shield, baffle plate, focus ring, insulator ring, shield ring, bellows cover, electrode, chamber liner, cathode liner, gas distribution plate, electrostatic chucks (for example, the sidewalls of electrostatic chucks), and the like. This invention is generally applicable to components subjected to corrosive environments such as internal member components for plasma treating vessels. This invention provides corrosive barrier systems that are suitable for protecting the surfaces of such internal member components. While the advantages of this invention will be described with reference to internal member components, the teachings of this invention are generally applicable to any component on which a corrosive barrier coating may be used to protect the component from a corrosive environment.

According to this invention, internal member components intended for use in corrosive environments of plasma treating vessels are thermal spray coated with a protective coating layer. The thermal sprayed coated internal member component formed by the method of this invention can have desired corrosion resistance, plasma erosion resistance, and wear resistance.

The coatings of this invention are useful for chemical processing equipment used at low and high temperatures, e.g., in harsh erosive and corrosive environments. In harsh environments, the equipment can react with the material being processed therein. Ceramic materials that are inert towards the chemicals can be used as coatings on the metallic equipment components. The ceramic coatings should be impervious to prevent erosive and corrosive materials from reaching the metallic equipment. A coating which can be inert to such erosive and corrosive materials and prevent the erosive and corrosive materials from reaching the underlying substrate will enable the use of less expensive substrates and extend the life of the equipment components.

The thermal sprayed coatings of this invention show desirable resistance when used in an environment subject to plasma erosion action in a gas atmosphere containing a halogen gas. For example, even when plasma etching operation is continued over a long time, the contamination through particles in the deposition chamber is less and a high quality internal member component can be efficiently produced. By the practice of this invention, the rate of generation of particles in a plasma process chamber can become slower, so that the interval for the cleaning operation becomes longer increasing productivity. As a result, the coated internal members of this invention can be effective in a plasma treating vessel in a semiconductor production apparatus. Also, internal members coated with a thermal spray coating of this invention exhibit good erosion resistance.

As indicated above, this invention relates to a method for protecting a metal or non-metal substrate by applying a thermally sprayed coating to the metal or non-metal substrate. The thermally sprayed coating is a ceramic coating having a functionally graded porosity across the ceramic coating thickness. The thickness extends along a path starting at a point adjacent to the surface of the metal or non-metal substrate, and proceeds to a point on the surface of the ceramic coating. The ceramic coating includes an inner layer and an outer layer. The inner layer has a porosity at or near the interface of the inner layer and the metal or non-metal substrate sufficient to provide a compliant ceramic coating capable of straining under thermal expansion mismatch between the ceramic coating and the metal or non-metal substrate at elevated temperature. The outer layer has a decreasing porosity from the surface of the inner layer to the surface of the ceramic coating sufficient to provide corrosion resistance and/or plasma erosion resistance to said ceramic coating.

The thermal spray coatings of this invention, in comparison to the corrosion and/or erosion resistance provided to a substrate by a corresponding non-graded ceramic coating, provide about 25 percent or greater corrosion and/or erosion resistance to the substrate, preferably about 40 percent or greater corrosion and/or erosion resistance to the substrate, and more preferably about 50 percent or greater corrosion and/or erosion resistance to the substrate.

It should be apparent to those skilled in the art that this invention may be embodied in many other specific forms without departing from the spirit of scope of the invention.

### Example 1

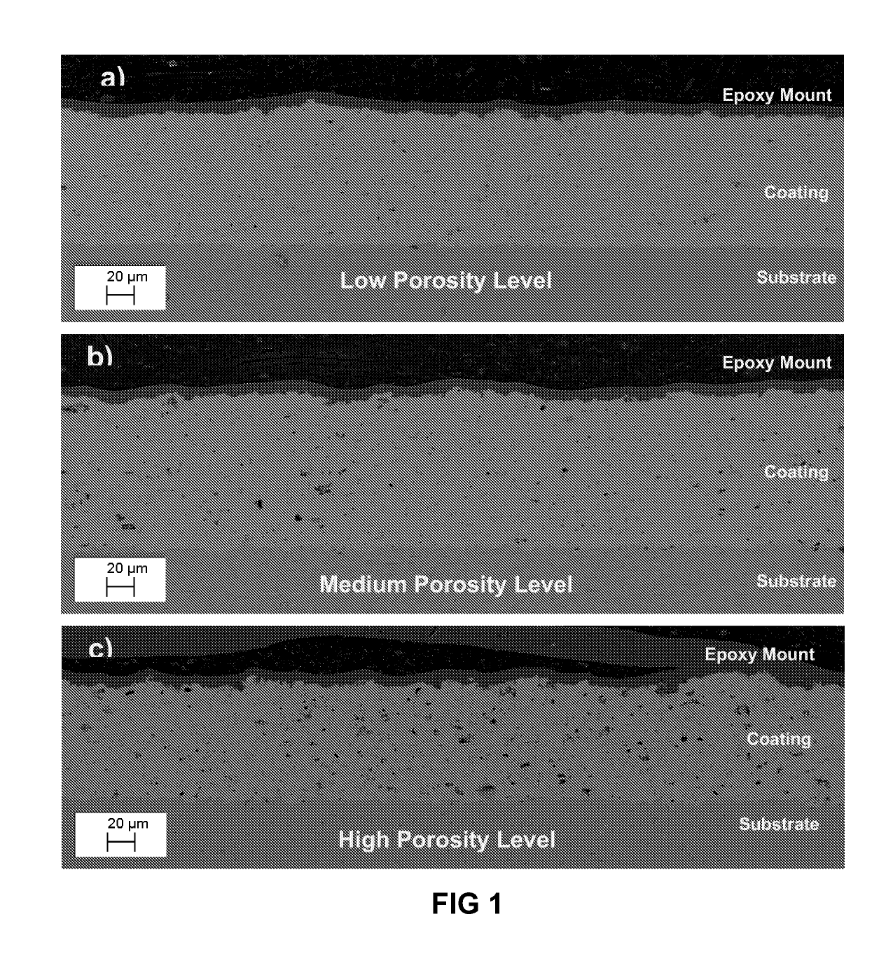

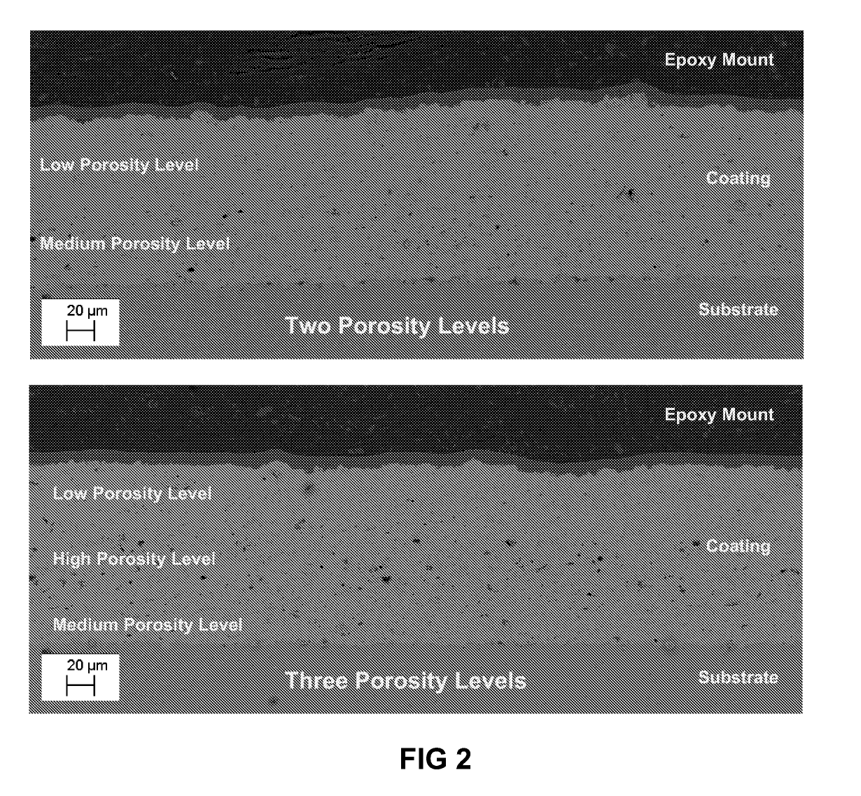

Feasibility of manufacturing functionally graded porosity coatings for improved performance at higher processing temperatures due to greater compliance at the coating-substrate interface, while maintaining a dense coating at the surface for the best plasma erosion resistance, was documented through scanning electron microscopy (SEM) micrographs of coating cross-sections. A number of conditions were presented to demonstrate the process control capabilities. First, three variances in porosity levels were presented (see FIGS. 1a, b, and c) to establish a baseline prior to incorporating these various porosity levels into a functionally graded porosity coating, as shown in FIG. 2 (the top and bottom micrographs).

It is noted that the 2-D void area established in the x-sectional images is not equivalent to the porosity level of a coating, which is established by a bulk density measurement. But, as shown in Example 2, the 2-D void area measured by cross-sectional analysis method ASTM E 2109-01 did directly correlate to increases in porosity levels as measured by the density method ASTM B 328-96. Therefore, one can assert changes in 2-D void area presented here are analogous to increases in porosity for the given coating condition.

FIG. 1 shows three coatings, each with distinct levels of porosity, which are characterized by 2-D cross-sectional analysis under SEM. The three porosity levels will be referred to generically as low, medium, and high. FIG. 1a presents a 2-D porosity level of 0-0.5% (low), which increases to 0.5-1.0% (medium) in FIG. 1b, and again increases to 1.0-2.5% (high) in FIG. 1c. One can clearly distinguish visually the void area in the coating increases from FIG. 1a to FIG. 1c due to changes in processing conditions, which can include gas flows, torch current and voltage, stand-off distances, surface speeds, advance rates, and gas chemistry.

FIG. 2 shows two functionally graded porosity coatings that incorporate the individual porosity levels presented in FIGS. 1(a, b, and c). FIG. 2 (top micrograph) shows a functionally graded porosity coating with two levels of porosity: medium porosity at the interface and low porosity at the surface. FIG. 2 (bottom micrograph) shows a functionally graded porosity coating with three levels of porosity: medium porosity at the interface, high porosity in the interior, and low porosity at the surface.

### Example 2

The observed 2-D porosity levels, i.e. 2-D void areas, were linked to physical properties. The density, hardness, and modulus were measured for the coatings presented in FIGS. 1(a, b, and c) with porosity levels of low, medium, and high. This data provides a direct correlation between changes in coating porosity levels and mechanical properties of plasma sprayed coatings utilized in the semiconductor components field. Specifically, attention is focused on documenting compliance changes as a function of porosity levels; substantiating the claims of tailoring compliance through porosity. In addition, the data supports increased coating density at the free surface results in lower plasma erosion rates. The functionally graded porosity coatings for use as semiconductor components tailor both properties to attain optimum performance in both thermal compliance and plasma erosion resistance through a single coating.

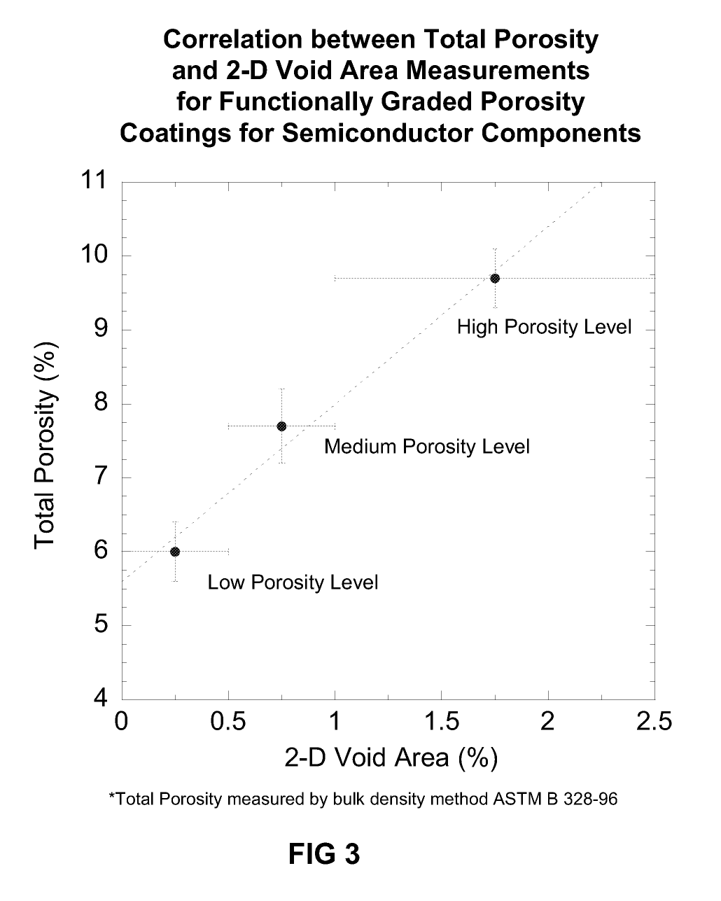

FIG. 3 shows a plot of the 2-D void area measured by cross-sectional analysis method ASTM E 2109-01 versus the total porosity levels as measured by the density method ASTM B 328-96 for the coatings presented in FIGS. 1(a, b, and c). Increases in 2-D void area were linked to increases in total porosity, and controlled shifts observed in the 2-D void area were associated with shifts in the total porosity of the coating. Therefore, the varying levels of 2-D voids observed for the functionally graded porosity coatings presented in FIG. 2 are understood to correlate varying levels of total porosity as a function of position.

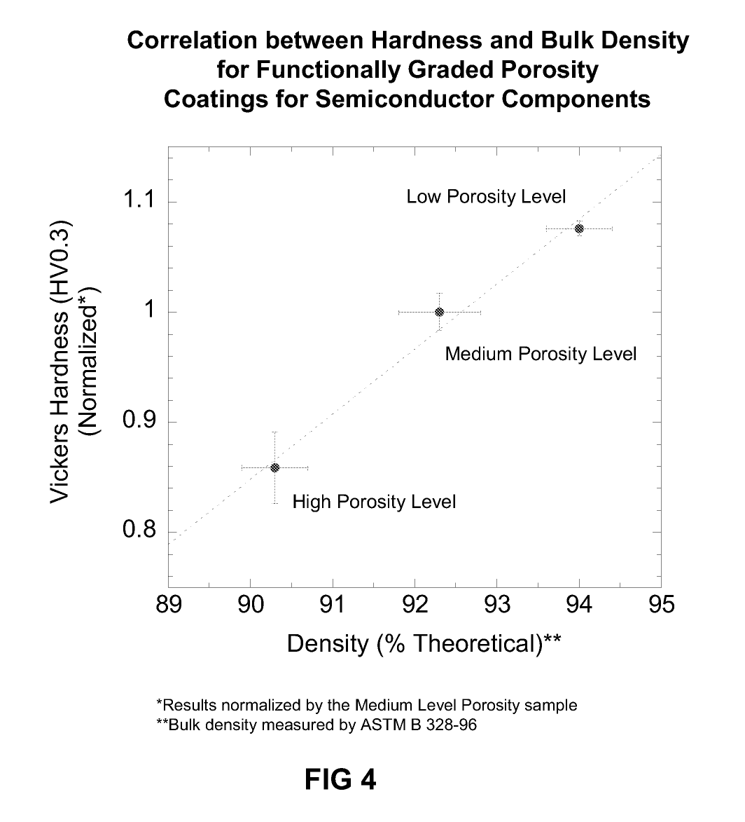

The effect of percentage of theoretical density on the hardness of the coating is presented in FIG. 4 for the coating conditions presented previously in FIGS. 1(a, b, and c). Coatings with higher density, i.e. lower total porosity, result in a higher Vickers Hardness number. Hardness serves as a method of quantifying a materials resistance to permanently deform, and in this case a direct measure of the contributing effect porosity plays.

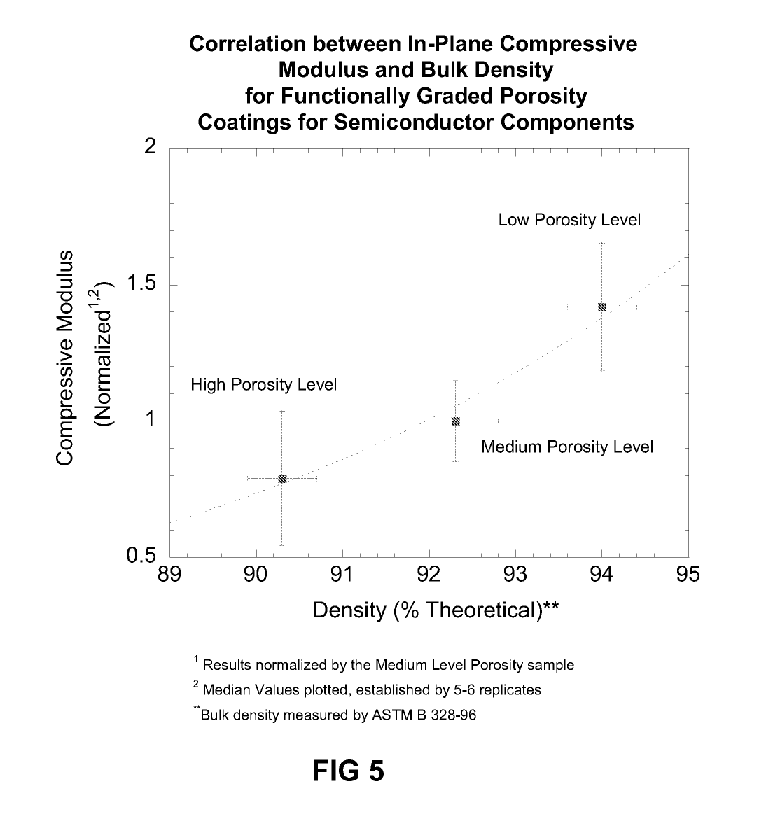

The compressive modulus of coatings was measured as a function of porosity level to establish a controlled link between tailoring the porosity level and controlling the coating's compliance. The modulus was measured on stand-alone coatings in a monotonic uniaxial compression method consistent with that previously described in the journal paper by C. Petorak and R. Trice, Surface & Coatings Technology 205 (2011) 3211-3217. FIG. 5 shows the measured results for compressive modulus as a function of the density for coatings presented in FIGS. 1(a, b, and c). The values plotted represent the median values measured from 5-6 replicate samples per condition. Coatings with higher density, i.e. lower porosity, result in a less compliant coating, i.e. a coating with a higher compressive modulus. The results distinguish obtainable shifts in modulus through changes in coating porosity, which are controllable through processing changes.

While compliance may be desirable at the interface to allow tools to operate at higher temperatures, porous coatings are generally not desirable at the free surface for semiconductor components. The free surface is exposed to harsh plasma erosive and corrosive conditions. Instead, a dense coating is preferred for the free surface to aid in a low plasma erosion rate that increases semiconductor tool lifetime. FIG. 5 shows the effect porosity has on plasma erosion for a yttria coating. Coatings with various porosity levels from 92-94% were subjected to a 60 hour reactive ion etch (RIE) utilizing a CF₄:O₂ chemistry. The thickness loss was then documented per condition. It was observed that coatings with higher relative densities, i.e. lower total porosities, provided increased plasma erosion protection.

### Example 3

Processing temperatures that are higher than conventional processing temperatures used in the semiconductor etch industry, e.g., greater than 100° C., are needed to achieve higher etch rates (both metal and dielectric etch) for higher wafer throughput from etch processes. As the process temperature increases, thermal stresses in the coating increase in magnitude due to thermal mismatch between the coating and substrate. Coating failure, e.g. delamination and cracking, will result when the magnitude of the thermal stress exceeds the strain capabilities of the coating. Increasing a coating's compliance will aid in mitigating the increased thermal strain experienced at higher processing temperatures. The compliance of a thermal spray coating can be increased or decreased depending on the level of porosity, and free surfaces associated with that porosity, present at the interlamellar and intralamellar pores. Providing a coating that is functionally graded in porosity allows the coating to be compliant at the interface while still providing the optimum plasma erosion resistance at the free surface.

The ability of functionally graded coatings to survive at higher process temperatures was evaluated by thermal cycling tests at 300° C. A single thermal cycle consisted of placing room temperature samples into a preheated oven at 300° C., allowing them to fully soak at temperature, and then removing the samples from the oven to cool at room temperature in air. The coatings were applied to roughened 6061 aluminum bond caps, and bond strength tested consistent with ASTM C633. Bare aluminum was chosen over an anodized aluminum or alumina substrate due to the large thermal mismatch between yttria and aluminum, which is on an order of magnitude in difference. The bond strength of the half of a coating group was tested in the as-coated condition, no thermal cycles, while the other half experienced 10 total thermal cycles prior to bond strength testing.

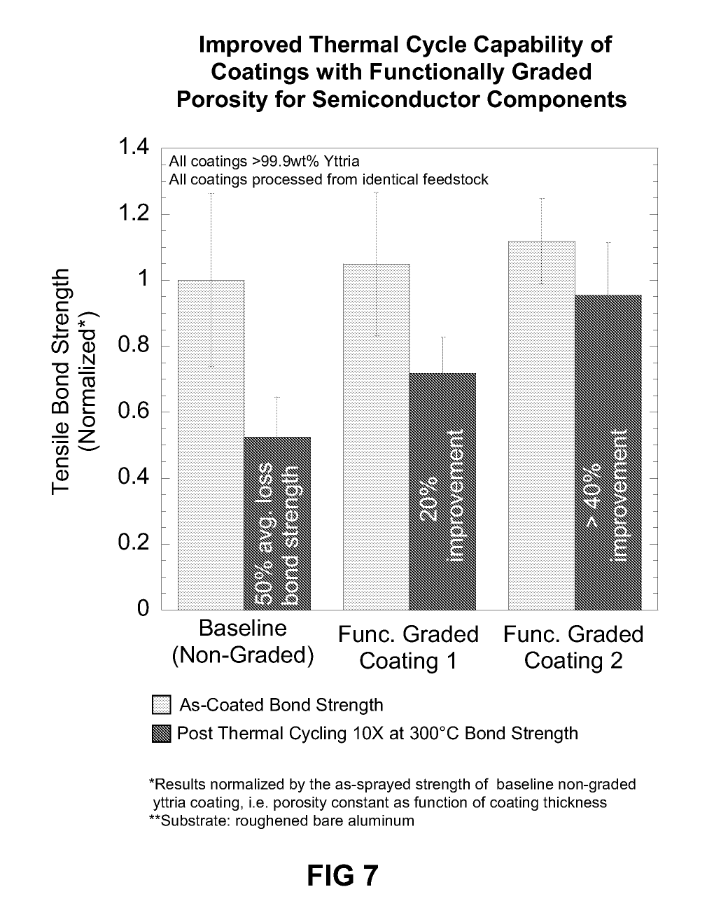

Tensile bond strength results of the as-coated versus the thermally cycled conditions of standard yttria coatings, i.e. baseline, and yttria coatings with functionally graded porosity are presented in FIG. 7. The standard or baseline yttria coatings, i.e. constant porosity, experienced a degradation in average bond strength of roughly 50%. In comparison, Functionally Graded Coating 2 in FIG. 7 retained an average bond strength post thermal cycling at 300° C. that was equal to 95% of the as-coated baseline bond strength. These results demonstrate how a coating with functionally graded porosity can perform in semiconductor chambers at process temperatures ranges that exceed those a conventional coating are capable of withstanding without thermo-mechanical damage. The results provide data to support the claim that a coating with a functionally graded porosity will provide longer lifetime and improved corrosion and plasma erosion protection due to lower levels of thermo-mechanical degradation taking place when compared with conventional non-graded coatings.

1. A thermal spray coating on a metal or non-metal substrate, said thermal spray coating comprising a ceramic coating having a functionally graded porosity across the ceramic coating thickness, said thickness extending along a path starting at a point adjacent to the surface of the metal or non-metal substrate and proceeding to a point on the surface of the ceramic coating, said ceramic coating comprising an inner layer and an outer layer, said inner layer having a porosity at or near the interface of said inner layer and said metal or non-metal substrate sufficient to provide a compliant ceramic coating capable of straining under thermal expansion mismatch between said ceramic coating and said metal or non-metal substrate at elevated temperature, and said outer layer having a decreasing porosity from the surface of the inner layer to the surface of the ceramic coating sufficient to provide corrosion resistance and/or plasma erosion resistance to said ceramic coating.

2. The thermal spray coating of claim 1 wherein said inner layer has a porosity of from about 5% to about 18%, and said outer layer has a porosity that decreases from about 18% at the surface of the inner layer to about 1% at the surface of the ceramic coating.

3. The thermal spray coating of claim 1 wherein the functionally graded porosity across the ceramic coating thickness is smooth or discrete.

4. The thermal spray coating of claim 1 wherein said inner layer comprises one or more sublayers.

5. The thermal spray coating of claim 1 wherein said outer layer comprises one or more sublayers.

6. The thermal spray coating of claim 1 wherein said inner layer has a smooth or discrete functionally graded porosity across the inner layer thickness.

7. The thermal spray coating of claim 1 wherein said outer layer has a smooth or discrete functionally graded porosity across the outer layer thickness.

8. The thermal spray coating of claim 1 which comprises yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

9. The thermal spray coating of claim 1 which comprises yttrium oxide.

10. The thermal spray coating of claim 1 wherein said metal or non-metal substrate is anodized prior to applying said thermal spray coating.

11. The thermal spray coating of claim 1 wherein said metal or non-metal substrate comprises an internal member of a plasma treating vessel.

12. The thermal spray coating of claim 11 wherein said internal member is selected from a deposit shield, baffle plate, focus ring, insulator ring, shield ring, bellows cover, electrode, chamber liner, cathode liner, gas distribution plate, and electrostatic chuck.

13. The thermal spray coating of claim 11 wherein the plasma treating vessel is used in the production of an integrated circuit component.

14. The thermal spray coating of claim 1 which is applied by a plasma coating method, a high-velocity oxygen fuel coating method, a detonation coating method or a cold spraying method.

15. A process for producing a thermal spray coating on a metal or non-metal substrate, said thermal spray coating comprising a ceramic coating having a functionally graded porosity across the ceramic coating thickness, said thickness extending along a path starting at a point adjacent to the surface of the metal or non-metal substrate and proceeding to a point on the surface of the ceramic coating, said ceramic coating comprising an inner layer and an outer layer, said inner layer having a porosity at or near the interface of said inner layer and said metal or non-metal substrate sufficient to provide a compliant ceramic coating capable of straining under thermal expansion mismatch between said ceramic coating and said metal or non-metal substrate at elevated temperature, and said outer layer having a decreasing porosity from the surface of the inner layer to the surface of the ceramic coating sufficient to provide corrosion resistance and/or plasma erosion resistance to said ceramic coating; said process comprising (i) feeding at least one ceramic coating material to a thermal spray device, (ii) operating said thermal spray device to deposit the at least one ceramic coating material on said metal or non-metal substrate to produce the ceramic coating, and (iii) varying at least one operating parameter of the thermal spray device during deposition of said at least one ceramic coating material sufficient to vary porosity of the ceramic coating.

16. The process of claim 15 wherein the operating parameters of the thermal spray device that can be varied comprise standoff of the thermal spray device, temperature of the depositing the at least one ceramic coating material, and velocity of the depositing at least one ceramic coating material as it contacts the metal or non-metal substrate.

17. The process of claim 15 wherein said at least one ceramic coating material is heated to about its melting point to form droplets of the at least one ceramic coating material, and the droplets are accelerated in a gas flow stream to contact said metal or non-metal substrate.

18. The process of claim 17 wherein the temperature parameters of the at least one ceramic coating material comprise temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

19. The process of claim 17 wherein the velocity parameters of the at least one ceramic coating material comprise gas flow rate; size and shape distribution of the droplets; and mass injection rate and density of the droplets.

20. The process of claim 15 wherein the thermal spray device is selected from a plasma spray device, a high velocity oxygen fuel device, a detonation gun, and an electric wire arc spray device.

21. An article comprising a metal or non-metal substrate and a thermal spray coating on the surface thereof; said thermal spray coating comprising a ceramic coating having a functionally graded porosity across the ceramic coating thickness, said thickness extending along a path starting at a point adjacent to the surface of the metal or non-metal substrate and proceeding to a point on the surface of the ceramic coating, said ceramic coating comprising an inner layer and an outer layer, said inner layer having a porosity at or near the interface of said inner layer and said metal or non-metal substrate sufficient to provide a compliant ceramic coating capable of straining under thermal expansion mismatch between said ceramic coating and said metal or non-metal substrate at elevated temperature, and said outer layer having a decreasing porosity from the surface of the inner layer to the surface of the ceramic coating sufficient to provide corrosion resistance and/or plasma erosion resistance to said ceramic coating.

22. The article of claim 21 wherein the thermal spray coating comprises yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

23. The article of claim 21 which comprises an internal member of a plasma treating vessel.

24. The article of claim 23 wherein said internal member is selected from a deposit shield, baffle plate, focus ring, insulator ring, shield ring, bellows cover, electrode, chamber liner, cathode liner, gas distribution plate, and electrostatic chuck.

25. A method for protecting a metal or non-metal substrate, said method comprising applying a thermally sprayed coating to said metal or non-metal substrate, said thermally sprayed coating comprising a ceramic coating having a functionally graded porosity across the ceramic coating thickness, said thickness extending along a path starting at a point adjacent to the surface of the metal or non-metal substrate and proceeding to a point on the surface of the ceramic coating, said ceramic coating comprising an inner layer and an outer layer, said inner layer having a porosity at or near the interface of said inner layer and said metal or non-metal substrate sufficient to provide a compliant ceramic coating capable of straining under thermal expansion mismatch between said ceramic coating and said metal or non-metal substrate at elevated temperature, and said outer layer having a decreasing porosity from the surface of the inner layer to the surface of the ceramic coating sufficient to provide corrosion resistance and/or plasma erosion resistance to said ceramic coating.
